(19) United States
(12) Patent Application Publication
(10) Pub. No.: US 2009/0298592 A1
(43) Pub. Date: Dec. 3, 2009

(54) APPARATUS AND METHOD FOR REMOTE INTERACTIVE AMUSEMENT AND SYSTEM USING THE SAME

(76) Inventors: Chia-Sheng Chen, Hsinchu City (TW); Ching-Fu Hung, Hsinchu City (TW); Chih-Chang Chien, Hsinchu City (TW); Li Sheng Lo, Chu Pei City (TW)

Correspondence Address: Muncy, Geissler, Olds & Lowe, PLLC, P.O. BOX 1364, FAIRFAX, VA, 22038-1364, US

(21) Appl. No.: 12/276,914

(22) Filed: Nov. 24, 2008

(30) Foreign Application Priority Data
Jun. 3, 2008 (TW) 097120538

(51) Int. Cl. A63F 9/24; A63F 13/00

(52) U.S. Cl. 463/40

(57) ABSTRACT

The invention relates to an apparatus and a method for remote interactive amusement. The method includes: providing a first computing apparatus and a second computing apparatus; providing a remote interactive amusement apparatus; and connecting the remote interactive amusement apparatus to the first computing apparatus; and connecting the first computing apparatus and the second computing apparatus to an Internet server. When the first computing apparatus is coupled to the remote interactive amusement apparatus through a computing apparatus connecting interface and the first computing apparatus receives a first specific instruction transmitted from the second computing apparatus, the first computing apparatus transmits a second specific instruction to the remote interactive amusement apparatus through the computing apparatus connecting interface according to the first specific instruction, and the remote interactive amusement apparatus responds a specific response according to the second specific instruction.

This application claims priority of No. 097120538 filed in Taiwan R.O.C. on Jun. 3, 2008 under 35 USC 119, the entire content of which is hereby incorporated by reference.

### BACKGROUND OF THE INVENTION

1. Field of Invention

The invention relates to an amusement apparatus, and more particularly to an apparatus and a method for remote interactive amusement.

2. Related Art

With the progress of the technology, the electronic technology has been advanced from the earliest vacuum tube and transistor to the integrated circuit chip, which can be widely used. Thus, the electronic product gradually becomes the indispensable necessities in the life of the modern human beings. Many articles, such as an electric piano, an electric tooth brush and the like, have been gradually electrized for the purpose of facilitating the usage.

Recently, the popular electronic audio-visual amusement apparatus is mainly an interactive amusement apparatus. The so-called interactive amusement apparatus can output an active action. For example, the earlier “electronic pet” available in the market is the interactive amusement apparatus. The “electronic pet” is a game console, which actively responds with a user command. In addition, the most popular interactive amusement apparatus is the Wii game console manufactured by the Nintendo Company, and the player can interact with the images on the display screen by the real striking and waving actions so that a lot of amusement fun can be obtained.

However, all the interactive amusement apparatuses mentioned hereinabove have the restriction of the interaction between the man and the machine.

### SUMMARY OF THE INVENTION

It is therefore an objective of the invention to provide a remote interactive amusement apparatus for responding a specific response when a remote instruction comes so that a local user may obtain the entertainment effect.

Another objective of the invention is to provide a remote interactive amusement method, through which at least two remote users can interact with each other to obtain the entertainment effects.

Still another objective of the invention is to provide a remote interactive amusement system, through which a remote user and a local user can interact with each other to obtain the entertainment effects via the Internet.

To achieve the above-mentioned or other objectives, the invention provides a remote interactive amusement apparatus to be connected to an Internet server through a first computing apparatus. The remote interactive amusement apparatus includes an output apparatus, an event controller and a computing apparatus connecting interface. The output apparatus responds a first specific response. The event controller is coupled to the output apparatus. The computing apparatus connecting interface is coupled to the event controller and configured to be coupled to the first computing apparatus. When a second computing apparatus is connected to the first computing apparatus through the Internet server, and the first computing apparatus receives a first specific instruction outputted from the second computing apparatus, the first computing apparatus transmits a second specific instruction to the event controller through the computing apparatus connecting interface according to the first specific instruction, and the event controller enables the output apparatus to respond the first specific response according to the second specific instruction.

In the remote interactive amusement apparatus according to the preferred embodiment of the invention, when the second computing apparatus is connected to a second remote interactive amusement apparatus, the remote interactive amusement apparatus further includes an input device coupled to the event controller. When the second computing apparatus is connected to the first computing apparatus through the Internet and the input device receives an input instruction, the input device converts the input instruction into an electronic signal and transmits the electronic signal to the event controller. Next, the event controller transmits a third specific instruction through the computing apparatus connecting interface according to the electronic signal. Then, the first computing apparatus transmits a fourth specific instruction to the second computing apparatus through the Internet server according to the third specific instruction so that the second remote interactive amusement apparatus connected to the second computing apparatus responds a second specific response.

In the remote interactive amusement apparatus according to the preferred embodiment of the invention, the output apparatus may be implemented by a light-emitting diode (LED). At this time, the first specific response is a specific color light ray generated by the LED. In addition, the output apparatus may be implemented by a speaker. At this time, the first specific response is a specific sound effect generated by the speaker. In one embodiment, the input device may be implemented by a contact sensor, which may be a button or a touch sensor. In addition, the first computing apparatus and the second computing apparatus are connected to the Internet server through specific text real-time communication software in one specific embodiment.

The invention also provides a remote interactive amusement method including the steps of: providing a first computing apparatus and a second computing apparatus; providing a first remote interactive amusement apparatus; connecting the first remote interactive amusement apparatus to the first computing apparatus; connecting the first computing apparatus and the second computing apparatus to an Internet server; and transmitting a second specific instruction to the first remote interactive amusement apparatus through a computing apparatus connecting interface according to a first specific instruction, and enabling the first remote interactive amusement apparatus to respond a first specific response according to the second specific instruction when the first remote interactive amusement apparatus is coupled to the first computing apparatus through the computing apparatus connecting interface and the first computing apparatus receives the first specific instruction transmitted from the second computing apparatus through the Internet server. The second specific instruction is outputted from the first computing apparatus.

The remote interactive amusement method according to the preferred embodiment of the invention further includes the step of providing a second remote interactive amusement apparatus. When the second remote interactive amusement apparatus is coupled to the second computing apparatus through the computing apparatus connecting interface and the first remote interactive amusement apparatus receives an input instruction, the first remote interactive amusement apparatus converts the input instruction into a third specific instruction; the third specific instruction is transmitted to the first computing apparatus through the computing apparatus connecting interface; a fourth specific instruction is transmitted to the second computing apparatus through the Internet server according to the third specific instruction; and the second remote interactive amusement apparatus connected to the second computing apparatus responds a second specific response.

The method further includes the step of providing a light-emitting diode (LED) in the first remote interactive amusement apparatus, wherein the first specific response includes generating a specific color light ray through the LED. In one embodiment, the method further includes providing a speaker in the first remote interactive amusement apparatus, wherein the first specific response includes generating a specific sound effect through the speaker.

The invention further provides a remote interactive amusement system including a first computing apparatus, a first remote interactive amusement apparatus and a second computing apparatus. The first computing apparatus and the second computing apparatus are connected to an Internet server. The first remote interactive amusement apparatus is coupled to the first computing apparatus. When the first computing apparatus receives a first specific instruction transmitted from the second computing apparatus through the Internet server, the first computing apparatus transmits a second specific instruction to the first remote interactive amusement apparatus according to the first specific instruction, and then responds a first specific response according to the second specific instruction.

In the remote interactive amusement system according to the preferred embodiment of the invention, the first remote interactive amusement apparatus includes an output apparatus, an event controller and a computing apparatus connecting interface. The output apparatus responds the first specific response. The event controller is coupled to the output apparatus. The computing apparatus connecting interface is coupled to the event controller and configured to be coupled to the first computing apparatus. When the first computing apparatus receives the first specific instruction outputted from the second computing apparatus, the first computing apparatus transmits the second specific instruction to the event controller through the computing apparatus connecting interface according to the first specific instruction, and enables the output apparatus to respond the first specific response according to the second specific instruction. When the first computing apparatus receives the first specific instruction outputted from the second computing apparatus, the first computing apparatus transmits the second specific instruction to the event controller through the computing apparatus connecting interface according to the first specific instruction, and the event controller enables the output apparatus to respond the first specific response according to the second specific instruction. In one embodiment, the remote interactive amusement system further includes a second remote interactive amusement apparatus coupled to the second computing apparatus. When the first remote interactive amusement apparatus receives an input instruction, the first remote interactive amusement apparatus converts the input instruction into a third specific instruction and transmits the third specific instruction to the first computing apparatus. Next, the first computing apparatus transmits a fourth specific instruction to the second computing apparatus through the Internet server according to the third specific instruction so that the second remote interactive amusement apparatus coupled to the second computing apparatus responds a second specific response.

In the remote interactive amusement system according to the preferred embodiment of the invention, the first remote interactive amusement apparatus further includes an input device coupled to the event controller. When the input device receives the input instruction, the input device converts the input instruction into an electronic signal, and transmits the electronic signal to the event controller. The event controller transmits the third specific instruction through the computing apparatus connecting interface according to the electronic signal. Next, the first computing apparatus transmits the fourth specific instruction to the second computing apparatus through the Internet server according to the third specific instruction so that the second remote interactive amusement apparatus coupled to the second computing apparatus responds the second specific response.

The spirit of the invention is to connect a remote interactive amusement apparatus to an Internet server through a computing apparatus. Thus, when the computing apparatus used by a local user receives an Internet message, which is transmitted from another user to the local user through the Internet server, the remote interactive amusement apparatus responds a specific response according to the Internet message. Similarly, when the user at the other end also has the same or similar remote interactive amusement apparatus, the same effect can also be achieved through the invention. Thus, the invention can provide the interactive entertainment effect to one of at least two remote users.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a block diagram showing a remote interactive amusement system according to a first embodiment of the invention.

FIG. 2 is a circuit block diagram showing a remote interactive amusement apparatus according to the first embodiment of the invention.

FIG. 3 is a block diagram showing a remote interactive amusement system according to a second embodiment of the invention.

FIG. 4 is a circuit block diagram showing the remote interactive amusement apparatus according to the second embodiment of the invention.

FIG. 5 is a flow chart showing a remote interactive amusement method according to a third embodiment of the invention.

FIG. 6 is a flow chart showing another remote interactive amusement method according to the third embodiment of the invention.

### DETAILED DESCRIPTION OF THE INVENTION

The present invention will be apparent from the following detailed description, which proceeds with reference to the accompanying drawings, wherein the same references relate to the same elements.

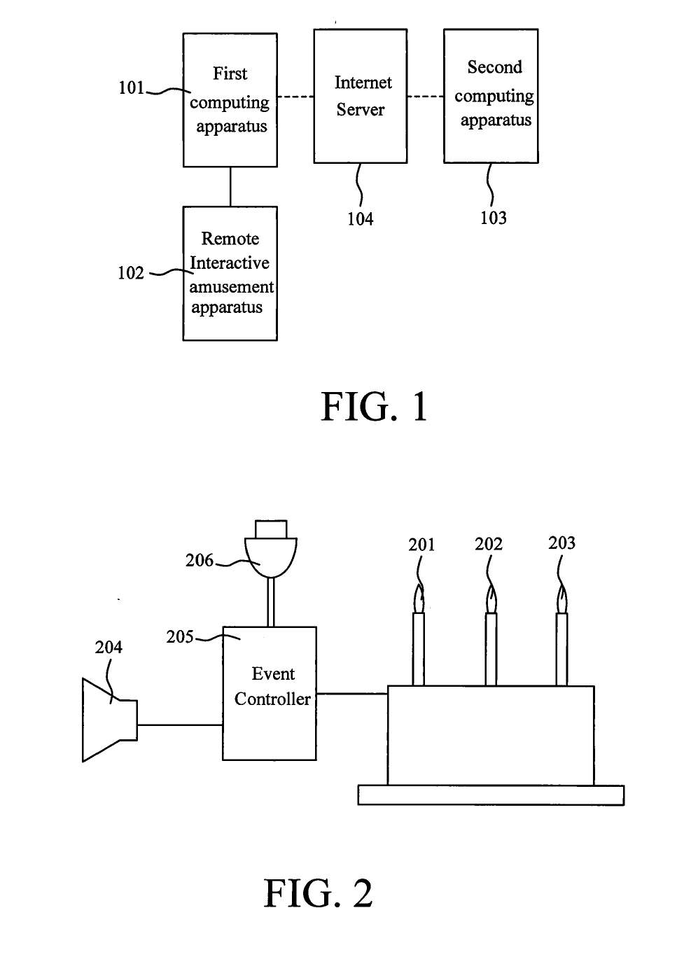

FIG. 1 is a block diagram showing a remote interactive amusement system according to a first embodiment of the invention. Referring to FIG. 1, the remote interactive amusement system includes a first computing apparatus 101, a remote interactive amusement apparatus 102, a second computing apparatus 103 and an Internet server 104. The first computing apparatus 101 and the second computing apparatus 103 are connected to the Internet server 104.

In order to describe this embodiment more clearly, it is assumed that both the first computing apparatus 101 and the second computing apparatus 103 are personal computers, and the remote interactive amusement apparatus 102 is coupled to the first computing apparatus 101 through a universal serial bus (USB) connection port. Next, it is assumed that the first computing apparatus 101 and the second computing apparatus 103 are connected to the Internet server 104 through the Internet instant messaging software, such as Skype, MSN messenger, or the like. In addition, it is assumed that the remote interactive amusement apparatus 102 is an electronic cake. In this embodiment, the circuit of the assumed electronic cake is shown in FIG. 2. The electronic cake 102 includes LEDs 201 to 203, a speaker 204, an event controller 205 and a USB cable 206, wherein the connections therebetween are shown in FIG. 2.

Generally speaking, the user at the side of the electronic cake 102 has installed a driver or an application program for the electronic cake 102 in the personal computer 101 in advance. When the user at the side of the personal computer 103 transmits a specific message, such as “Happy Birthday To You”, to the user at the side of the personal computer 101 through the Internet instant messaging software, the personal computer 101 queries whether the instruction corresponding to the specific message exists through the driver or the application program after receiving the message. When the message does exist and the operation corresponding to the message is to light up the LEDs 201 to 203 of the electronic cake 102 and to enable the speaker 204 to play the song of “Happy Birthday To You”, the personal computer 101 outputs and transmits the above-mentioned instruction to the event controller 205 of the electronic cake 102 through the USB cable 206, and the event controller 205 controls the LEDs 201 to 203 to start to twinkle and controls the speaker 204 to play the song of “Happy Birthday To You” according to the instruction.

In the above-mentioned embodiment, although the first computing apparatus 101 and the second computing apparatus 103 are the personal computers, one of ordinary skill in the art may easily understand that a notebook computer, an Internet device or a personal digital assistant (PDA) may serve as the first computing apparatus 101 or the second computing apparatus 103. In addition, although the USB connection port is used in the above-mentioned embodiment, one of ordinary skill in the art may easily understand that the computer connecting interface further includes IEEE-1394, RS232 and wireless Bluetooth transmission. Thus, the above-mentioned coupling is not restricted to the coupling of the USB connection port as long as the signal can be transmitted to the computing apparatus, and the coupling may be implemented in a wireless transmission manner. So, the invention is not particularly restricted thereto.

In addition, although the Internet instant messaging software serves as the transmission medium in the above-mentioned embodiment, one of ordinary skill in the art may easily understand that the transmission medium needs not to be limited to the Internet instant messaging software, but may be the specific software designed and developed by the user as long as the software can connect the apparatus to an Internet server and can enable at least two computing apparatuses to communicate with each other according to a specific communication protocol. So, the invention is not particularly limited thereto.

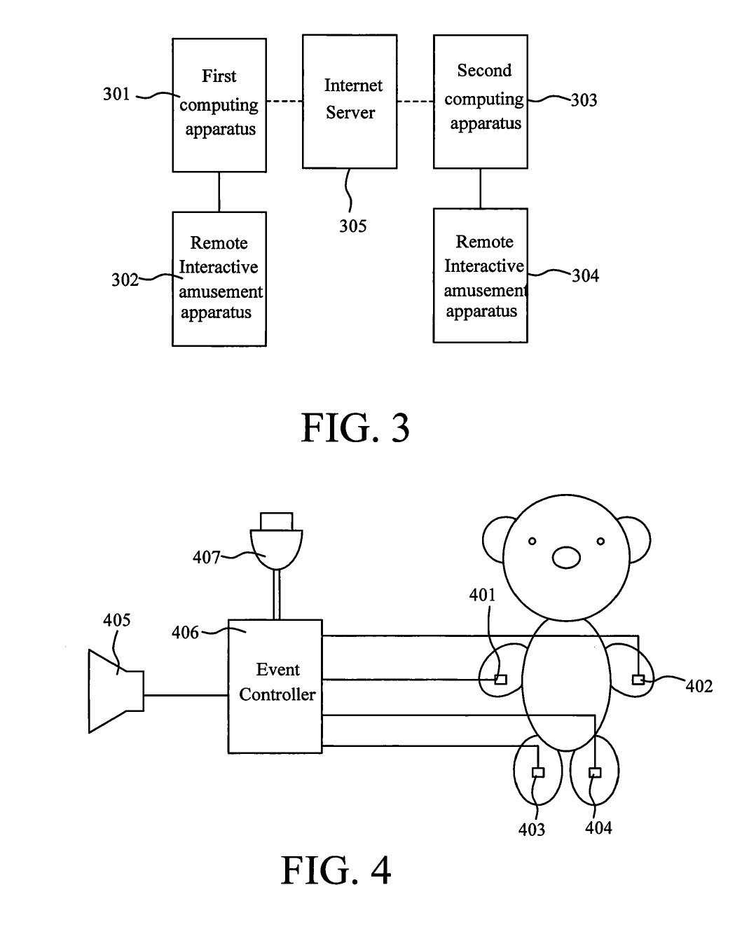

FIG. 3 is a block diagram showing a remote interactive amusement system according to a second embodiment of the invention. Referring to FIG. 3, the remote interactive amusement system includes a first computing apparatus 301, a first remote interactive amusement apparatus 302, a second computing apparatus 303, a second remote interactive amusement apparatus 304 and an Internet server 305. Similarly, both the first computing apparatus 301 and the second computing apparatus 303 are connected to the Internet server 305.

Similarly, in order to describe the second embodiment more clearly, it is assumed that the first computing apparatus 301 and the second computing apparatus 303 are personal computers, and the first remote interactive amusement apparatus 302 and the second remote interactive amusement apparatus 304 are respectively coupled to the first computing apparatus 301 and the second computing apparatus 303 through the USB connection ports. Next, it is assumed that the first computing apparatus 301 and the second computing apparatus 303 are connected to the Internet server 305 through the Internet instant messaging software, such as Skype, MSN messenger or the like. In addition, it is assumed that the first remote interactive amusement apparatus 302 and the second remote interactive amusement apparatus 304 are electronic dolls each having the circuit shown in FIG. 4. The electronic doll 302 or 304 includes four touch sensors 401 to 404, a speaker 405, an event controller 406 and a USB cable 407, and the connections between the elements are shown in FIG. 4.

Generally speaking, the users at the sides of the personal computers 301 and 303 have installed the drivers or application programs for the electronic dolls 302 and 304 in the personal computers 301 and 303. When the user at the side of the personal computer 301 is patting the electronic doll 302 through the Internet instant messaging software, one of the touch sensors 401 to 404 senses that it is touched. Thus, the event controller 406 receives the messages outputted from the touch sensors 401 to 404. Next, the event controller 406 judges the type of response according to the messages, wherein it is assumed that the type of response is a “cry”. After the judgement is finished, the event controller 406 transmits the message of “cry” to the personal computer 301 through the USB cable 407. After receiving the message, the personal computer 301 queries whether the instruction corresponding to the message exists through the driver or application program. When the message does exist and the message is “T_T”, the personal computer 301 transmits the message “T_T” to the personal computer 303 through the Internet instant messaging software. When the personal computer 303 receives the message “T_T”, it transmits the instruction corresponding to the message “T_T” to the event controller 406 of the electronic doll 304 through the USB cable 407 according to the above-mentioned control mechanism, and the event controller 406 controls the speaker 405 to play the crying sound according to the above-mentioned instruction.

In the above-mentioned embodiment, the first computing apparatus 301 controls the second remote interactive amusement apparatus 304 coupled to the second computing apparatus 303 by patting the first remote interactive amusement apparatus 302. However, one or ordinary skill in the art may easily understand that the second computing apparatus 303 may also control the first remote interactive amusement apparatus 302 by patting the second remote interactive amusement apparatus 304 according to the same means mentioned hereinabove. So, the invention can enable at least two users to interact with each other through the remote interactive amusement apparatuses 302 and 304. Similarly, three remote users also can interact with one another through the Internet instant messaging software as long as they have the remote interactive amusement apparatuses 302 coupled to their personal computers or their equivalent computing apparatuses. In addition, although the touch sensors are used in the above-mentioned embodiment, one of ordinary skill in the art should understand that the buttons or the equivalent contact sensors may also be adopted to implement the invention. So, the invention is not limited thereto.

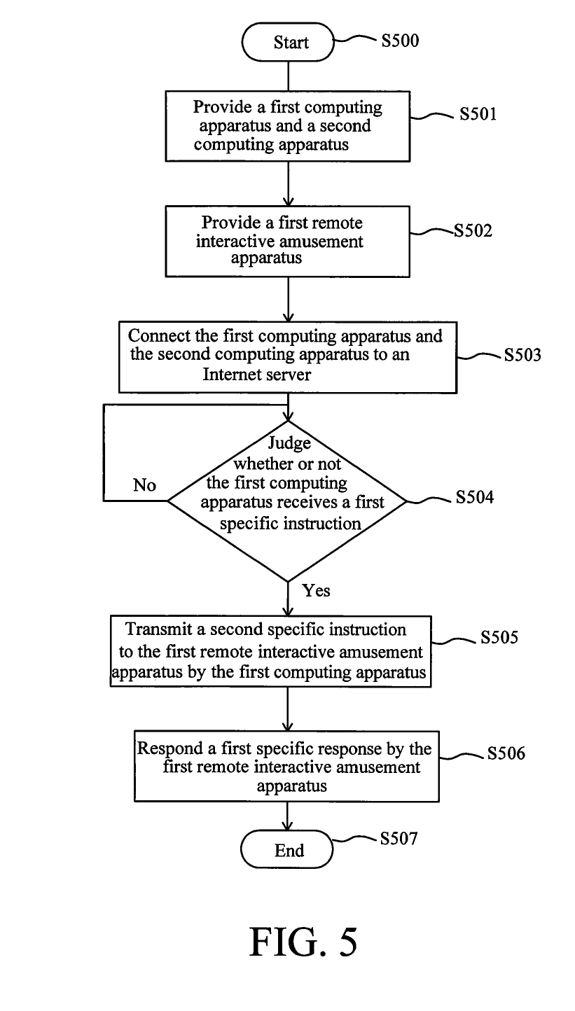

A remote interactive amusement method of the invention may be concluded according to the embodiment mentioned hereinabove. FIG. 5 is a flow chart showing a remote interactive amusement method according to a third embodiment of the invention. Referring to FIG. 5, the method includes the following steps.

In step S500, the method starts.

In step S501, a first computing apparatus and a second computing apparatus are provided.

In step S502, a first remote interactive amusement apparatus is provided. The first remote interactive amusement apparatus is coupled to the first computing apparatus. Similarly, the coupling in this embodiment is not restricted to the wired coupling, and the wireless coupling may also be adopted. For example, when a wireless Bluetooth transmission module is inserted into the USB transmission interface of the first computing apparatus, the first remote interactive amusement apparatus may also be coupled to the first computing apparatus according to the wireless Bluetooth protocol.

In step S503, the first computing apparatus and the second computing apparatus are connected to an Internet server.

In step S504, it is judged whether or not the first computing apparatus has received a first specific instruction, such as the short message of “Happy Birthday To You” or the short message of “T_T”, transmitted from the second computing apparatus.

In step S505, a second specific instruction is transmitted to the first remote interactive amusement apparatus through a computing apparatus connecting interface according to the first specific instruction, wherein the second specific instruction is outputted from the first computing apparatus.

In step S506, the first remote interactive amusement apparatus responds a first specific response according to the second specific instruction.

In step S507, the method ends.

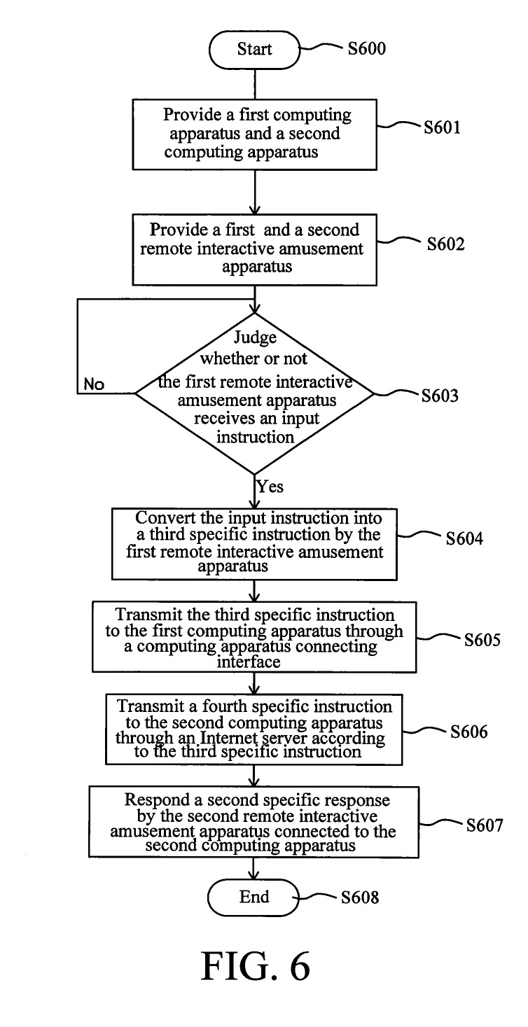

When the first computing apparatus and the second computing apparatus are respectively coupled to the first remote interactive amusement apparatus and a second remote interactive amusement apparatus, the remote interactive amusement method includes the steps shown in FIG. 6.

In step S600, the method starts.

In step S601, the first computing apparatus and the second computing apparatus are provided.

In step S602, the first remote interactive amusement apparatus and the second remote interactive amusement apparatus are provided, wherein the first remote interactive amusement apparatus and the second remote interactive amusement apparatus are respectively coupled to the first computing apparatus and the second computing apparatus.

In step S603, it is judged whether or not the first remote interactive amusement apparatus receives an input instruction. For example, whether or not the internal touch sensors 401 to 404 are touched is judged. When the input instruction is received, the procedure goes to step S604.

In the step S604, the first remote interactive amusement apparatus converts the input instruction into a third specific instruction. As shown in FIGS. 3 and 4, the step is to convert the received input instruction into a computer message that can be accepted by the personal computer 301.

In step S605, the third specific instruction is transmitted to the first computing apparatus through the computing apparatus connecting interface. As shown in FIGS. 3 and 4, the step is to transmit the converted computer message to the personal computer 301 through the USB cable 407.

In step S606, a fourth specific instruction is transmitted to the second computing apparatus through the Internet server according to the third specific instruction. As shown in FIGS. 3 and 4, the step is to convert the received third specific instruction into the fourth specific instruction satisfying the Internet communication protocol, and to transmit the fourth specific instruction to the personal computer 303.

In step S607, the second remote interactive amusement apparatus connected to the second computing apparatus responds a second specific response. Similarly, as shown in FIGS. 3 and 4, when the personal computer 303 receives the message “T_T”, it transmits the instruction corresponding to the message “T_T” to the event controller 406 of the electronic doll 304 through the USB cable 407 according to the above-mentioned control mechanism, and the event controller 406 controls the speaker 405 to play the crying sound according to the instruction.

In step S608, the method ends.

In summary, the spirit of the invention is to connect a remote interactive amusement apparatus to an Internet server through a computing apparatus. Thus, when the computing apparatus used by a local user receives an Internet message, which is transmitted from another user to the local user through the Internet server, the remote interactive amusement apparatus responds a specific response according to the Internet message. Similarly, when the user at the other end also has the same or similar remote interactive amusement apparatus, the same effect can also be achieved through the invention. Thus, the invention can provide the interactive entertainment effect to one of at least two remote users.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A remote interactive amusement apparatus to be connected to an Internet server through a first computing apparatus, the remote interactive amusement apparatus comprising:
an output apparatus for responding a first specific response;
an event controller coupled to the output apparatus; and
a computing apparatus connecting interface, which is coupled to the event controller and configured to be coupled to the first computing apparatus, wherein:
when a second computing apparatus is connected to the first computing apparatus through the Internet server, and the first computing apparatus receives a first specific instruction outputted from the second computing apparatus, the first computing apparatus transmits a second specific instruction to the event controller through the computing apparatus connecting interface according to the first specific instruction, and the event controller enables the output apparatus to respond the first specific response according to the second specific instruction.

2. The apparatus according to claim 1, wherein when the second computing apparatus is connected to a second remote interactive amusement apparatus, the remote interactive amusement apparatus further comprises:
an input device coupled to the event controller,
wherein when the second computing apparatus is connected to the first computing apparatus through an Internet and the input device receives an input instruction, the input device converts the input instruction into an electronic signal and transmits the electronic signal to the event controller, the event controller transmits a third specific instruction through the computing apparatus connecting interface according to the electronic signal, and the first computing apparatus transmits a fourth specific instruction to the second computing apparatus through the Internet server according to the third specific instruction so that the second remote interactive amusement apparatus connected to the second computing apparatus responds a second specific response.

3. The apparatus according to claim 1, wherein the computing apparatus connecting interface comprises:
a wireless transmission interface.

4. The apparatus according to claim 1, wherein the output apparatus comprises:
a light-emitting diode (LED), wherein the first specific response comprises generating a specific color light ray by the LED.

5. The apparatus according to claim 1, wherein the output apparatus comprises:
a speaker, wherein the first specific response comprises generating a specific sound effect by the speaker.

6. The apparatus according to claim 2, wherein the input device comprises a contact sensor.

7. The apparatus according to claim 6, wherein the contact sensor is selected from the group consisting of a button and a touch sensor.

8. The apparatus according to claim 1, wherein the first computing apparatus and the second computing apparatus are connected to the Internet server through specific text real-time communication software.

9. A remote interactive amusement method, comprising the steps of:
providing a first computing apparatus and a second computing apparatus;
providing a first remote interactive amusement apparatus;
connecting the first remote interactive amusement apparatus to the first computing apparatus;
connecting the first computing apparatus and the second computing apparatus to an Internet server; and
transmitting a second specific instruction to the first remote interactive amusement apparatus through a computing apparatus connecting interface according to a first specific instruction, and enabling the first remote interactive amusement apparatus to respond a first specific response according to the second specific instruction when the first remote interactive amusement apparatus is coupled to the first computing apparatus through the computing apparatus connecting interface and the first computing apparatus receives the first specific instruction transmitted from the second computing apparatus through the Internet server, wherein the second specific instruction is outputted from the first computing apparatus.

10. The method according to claim 9, further comprising the step of providing a second remote interactive amusement apparatus, wherein when the second remote interactive amusement apparatus is coupled to the second computing apparatus through the computing apparatus connecting interface and the first remote interactive amusement apparatus receives an input instruction:
the first remote interactive amusement apparatus converts the input instruction into a third specific instruction;
the third specific instruction is transmitted to the first computing apparatus through the computing apparatus connecting interface;
a fourth specific instruction is transmitted to the second computing apparatus through the Internet server according to the third specific instruction; and
the second remote interactive amusement apparatus connected to the second computing apparatus responds a second specific response.

11. The method according to claim 9, further comprising the step of:
providing a light-emitting diode (LED) in the first remote interactive amusement apparatus;
wherein the first specific response comprises generating a specific color light ray through the LED.

12. The method according to claim 9, further comprising the step of:
providing a speaker in the first remote interactive amusement apparatus,
wherein the first specific response comprises generating a specific sound effect through the speaker.

13. The method according to claim 9, wherein the first remote interactive amusement apparatus comprises a contact sensor, and the input instruction comprises:
contacting the contact sensor.

14. The method according to claim 9, wherein the computing apparatus connecting interface comprises a wireless transmission interface.

15. The method according to claim 9, wherein the first computing apparatus and the second computing apparatus are connected to the Internet server through specific text real-time communication software.

16. A remote interactive amusement system, comprising:
a first computing apparatus connected to an Internet server;
a first remote interactive amusement apparatus coupled to the first computing apparatus; and
a second computing apparatus connected to the Internet server,
wherein when the first computing apparatus receives a first specific instruction transmitted from the second computing apparatus through the Internet server, the first computing apparatus transmits a second specific instruction to the first remote interactive amusement apparatus according to the first specific instruction, and then responds a first specific response according to the second specific instruction.

17. The system according to claim 16, wherein the first remote interactive amusement apparatus comprises:
an output apparatus for responding the first specific response;
an event controller coupled to the output apparatus; and
a computing apparatus connecting interface, which is coupled to the event controller and configured to be coupled to the first computing apparatus,
wherein when the first computing apparatus receives the first specific instruction outputted from the second computing apparatus, the first computing apparatus transmits the second specific instruction to the event controller through the computing apparatus connecting interface according to the first specific instruction, and enables the output apparatus to respond the first specific response according to the second specific instruction.

18. The system according to claim 17, wherein the computing apparatus connecting interface comprises:
a wireless transmission interface.

19. The system according to claim 16, further comprising:
a second remote interactive amusement apparatus coupled to the second computing apparatus,
wherein when the first remote interactive amusement apparatus receives an input instruction, the first remote interactive amusement apparatus converts the input instruction into a third specific instruction and transmits the third specific instruction to the first computing apparatus, and the first computing apparatus transmits a fourth specific instruction to the second computing apparatus through the Internet server according to the third specific instruction to enable the second remote interactive amusement apparatus coupled to the second computing apparatus to respond a second specific response.

20. The system according to claim 17, wherein the first remote interactive amusement apparatus further comprises:
an input device coupled to the event controller;
wherein when the input device receives an input instruction, the input device converts the input instruction into an electronic signal and transmits the electronic signal to the event controller, the event controller transmits a third specific instruction through the computing apparatus connecting interface according to the electronic signal, and the first computing apparatus transmits a fourth specific instruction to the second computing apparatus through the Internet server according to the third specific instruction to enable a second remote interactive amusement apparatus coupled to the second computing apparatus to respond a second specific response.
